(19) United States
(12) Patent Application Publication
(10) Pub. No.: US 2019/0012592 A1
(43) Pub. Date: Jan. 10, 2019

(54) SECURE FEDERATED NEURAL NETWORKS

(71) Applicant: POINTR DATA INC., San Jose, CA (US)

(72) Inventors: Nurettin Burcak Beser, Palo Alto, CA (US); Saran Saund, Mountain View, CA (US); Paul Aerick Lambert, Mountain View, CA (US)

(21) Appl. No.: 16/029,465

(22) Filed: Jul. 6, 2018

Related U.S. Application Data
(60) Provisional application No. 62/529,921, filed on Jul. 7, 2017.
(60) Provisional application No. 62/529,947, filed on Jul. 7, 2017.

(51) Int. Cl. G06N 3/04; G06N 3/08; H04L 29/06; G06F 8/65

(52) U.S. Cl. CPC G06N 3/0454; G06F 8/65; H04L 63/0428; G06N 3/08

(57) ABSTRACT

A federated architecture of artificial neural networks includes a first federation comprising a first plurality of artificial neural networks; a second federation comprising a second plurality of artificial neural networks; and a central server in communication with the first plurality of artificial neural networks and with the second plurality of artificial neural networks; wherein at least one artificial neural network is in the first federation and in the second federation; wherein communication between the central server and the first plurality of artificial neural networks is based on the first federation; and wherein communication between the central server and the second plurality of artificial neural networks is based on the second federation.

### CROSS-REFERENCE TO RELATED APPLICATIONS

This application is a non-provisional patent application of, and claims priority to, U.S. Provisional Pat. App. No. 62/529,921, filed Jul. 7, 2017 and entitled “FEDERATED NEURAL NETWORKS,” and to U.S. Provisional Pat. App. No. 62/529,947, filed Jul. 7, 2017 and entitled “SECURE FEDERATED NEURAL NETWORK,” both of which are incorporated herein by reference in its entirety.

### FIELD

This disclosure relates to neural networks, such as are suitable for artificial intelligence. Such networks are used, for example, in airplanes, automobiles, boats, cameras, computers, data centers, data gathering devices, drones, medical applications, point-of-sale registers, registration set-ups, robots, surveillance applications, trains, trucks, under desks, in workspaces, etc., in industries such as, for example, healthcare, manufacturing, retail, surveillance, transportation, etc.

### BACKGROUND

Federated architectures enable federated learning, such as are suitable for edge computing in machine leaning, including neural networks used in deep artificial intelligence. In such distributed learning models, secure communication between a central server and clients within the federation is desired.

### SUMMARY

In various embodiments, a federated architecture of artificial neural networks includes a first federation comprising a first plurality of artificial neural networks; a second federation comprising a second plurality of artificial neural networks; and a central server in communication with the first plurality of artificial neural networks and with the second plurality of artificial neural networks; wherein at least one artificial neural network is in the first federation and in the second federation; wherein communication between the central server and the first plurality of artificial neural networks is based on the first federation; and wherein communication between the central server and the second plurality of artificial neural networks is based on the second federation.

In various embodiments: the communication is bi-directional; the communication is at least one of encrypted and authenticated using an asymmetrical cryptographic key pair; the communication includes metadata validation; the central server receives a first update based on first local data from the first plurality of artificial neural networks and a second update based on second local data from the second plurality of artificial neural networks; the central server aggregates the first update and the second update; and/or the central server aggregates the first update and the second update after the central server receives a predetermined number of updates.

In various embodiments, a computer-implemented method of operating a federated architecture of artificial neural networks includes federating a first plurality of artificial neural networks into a first federation; federating a second plurality of artificial neural networks into a second federation; identifying at least one artificial neural network that is in the first federation and in the second federation; downloading a central model from a central server to the first plurality of artificial neural networks and to the second plurality of artificial neural networks; computing a first local model within the first federation based on first local data applied to the central model; computing a second local model within the second federation based on second local data applied to the central model; drawing a first inference using the first local model within the first federation; drawing a second inference using the second local model within the second federation; uploading a first update from the first local model of the first federation to the central server; uploading a second update from the second local model of the second federation to the central server; receiving the first update and the second update at the central server; updating the central model at the central server based on the first update and the second update; and downloading an updated central model from the central server to the first plurality of artificial neural networks and to the second plurality of artificial neural networks.

In various embodiments: updating the central model at the central server based on the first update and the second update includes aggregating the first update and the second update; the aggregating occurs after receiving a specified number of updates from the federations before the aggregation; the central server discards the first update and the second update after the aggregation; at least one of the uploading and downloading comprises authentication; at least one of the uploading and the downloading comprises encryption; the method further includes validating the first update and the second update using metadata; the first federation benefits from the second update and the second federation benefits from the first update; and/or the first federation benefits from the second update and the second federation benefits from the first update via the artificial neural network that is in the first federation and in the second federation, after training locally on the first local model and the second local model.

In various embodiments, a non-transitory computer-readable medium embodying program code executable in at least one computing device, the program code, when executed by the at least one computing device, being configured to cause the at least one computing device to at least federate a first plurality of artificial neural networks into a first federation; federate a second plurality of artificial neural networks into a second federation; identify at least one artificial neural network that is in the first federation and in the second federation; download a central model from a central server to the first plurality of artificial neural networks and to the second plurality of artificial neural networks; compute a first local model within the first federation based on first local data applied to the central model; compute a second local model within the second federation based on second local data applied to the central model; draw a first inference using the first local model within the first federation; draw a second inference using the second local model within the second federation; upload a first update from the first local model of the first federation to the central server; upload a second update from the second local model of the second federation to the central server; receive the first update and the second update at the central server; update the central model at the central server based on the first update and the second update; and download an updated central model from the central server to the first plurality of artificial neural networks and to the second plurality of artificial neural networks.

In various embodiments: the program code is further configured to cause the at least one computing device to aggregate the first update and the second update to update the central model at the central server; the aggregation occurs after receiving a specified number of updates from the federations before the aggregation; and/or the program code is further configured to discard the first update and the second update after the aggregation.

### BRIEF DESCRIPTION OF THE DRAWINGS

The accompanying drawings illustrate various embodiments employing the principles described herein and are a part of the specification. The illustrated embodiments are meant for description only, and they do not limit the scope of the claims, and in which:

FIG. 1 is a representative, simplified illustration of a federated computer network of artificial neural networks, in various embodiments;

FIG. 2 is a representative, simplified illustration of computer componentry suitable for use in a federated computer network of artificial neural networks, in various embodiments; and

FIG. 3 illustrates a simplified method of operating a secure federated computer network of artificial neural networks, in various embodiments.

### DETAILED DESCRIPTION

This detailed description of exemplary embodiments references the accompanying drawings, which show exemplary embodiments by way of illustration. While these exemplary embodiments are described in sufficient detail to enable those skilled in the art to practice this disclosure, it should be understood that other embodiments may be realized and that logical changes and adaptations in design and construction may be made in accordance with this disclosure and the teachings herein described without departing from the scope and spirit hereof. Thus, this detailed description is presented for purposes of illustration only and not of limitation.

In accordance with various aspects of this disclosure, systems and methods are described for secure communications within a federated neural network.

Referring generally, an artificial neural network (ANN) is a subset of machine learning, which is a subset of artificial intelligence (AI). ANN's computing systems are not just programmed to perform specific tasks, they are programmed to learn how to perform specific tasks. For example, rather than following task-specific rules, ANNs are programmed to review programmed examples and draw non-programmed inferences from such datasets, in various embodiments. The more examples that an ANN reviews, the deeper its learning is said to be, giving rise to terms such as deep AI and/or deep learning.

Simplified to an exemplary extreme, programmers program ANNs to solve mathematical algorithms, or functions, such as by f(x)=y, in which x is a plurality of examples that an algorithm f is programmed to examine, and y is a result of the analysis. An algorithm is said to train by building the relationship f(x)=y, and when the algorithm is then used to predict a particular outcome y based on a particular input x, the algorithm is said to make an inference. In other words, there are, in general, two primary processes involved in machine learning: training and inference. In various embodiments, ANNs learn during training by examining massive datasets, and ANNs then use that learning from the training to apply and/or draw predictive inferences based on new, untrained datasets. As a result, outputs from ANNs comprise non-linear aggregations (e.g., averages, summations, etc.) of their inputs, enabling ANNs to process unsupervised (i.e., untrained) learning through pattern recognitions and/or the like. In various embodiments, ANNs are thus adaptive models that change their dynamic structures based on internal and external dataflows through the ANNs.

In various embodiments, machine learning relies on centralized models for training, in which groups of machines (e.g., servers and data centers) run computer models against large, centrally-located datasets. Federated learning, on the other hand, decentralizes AI from centralized learning models. More specifically, for example, federated architectures rely on distributed models for training, reviewing datasets from one or more federations of participating devices, in various embodiments. In other words, federated architectures gather vast quantities of data from large numbers of related, participating devices, without relying on, or using, centralized datasets to train models for optimization.

As applied to a network of neural networks, federated architectures use collections of one or more independent systems (e.g., ANNs) united into loosely coupled federations that exchange and share information. This association, or federation, consists of ANNs, of which there may be any number, and a central server, which is a special component of the overall network that maintains the federation and oversees, for example, the entry of new ANNs, in various embodiments. The federated ANNs control their interactions with the central server, and vice versa, using i) an export schema to specify what information flows from the ANN and/or central server, as well as ii) an import schema to specify what information flows into the ANN and/or central server.

In various embodiments, any one individual ANN may belong to one or more federations. Accordingly, federated architectures provide protocols for sharing data, combining data, and otherwise coordinating activities among the central server and/or otherwise autonomously-driven ANNs within a specified federation.

When processing power is embedded in each independent ANN, that processing power is crowd-shared with the central server, in various embodiments. This enables computing to occur at the edges of the network (i.e., edge-computing), in which data is collected from federated users and used to improve a central model maintained by the central server, which, in various embodiments, is cloud-based.

For example, in a distributed AI model, the central server maintains and downloads a central algorithm to various ANNs within one or more federations. In various embodiments, this central algorithm is therefore commonly applied to multiple ANNs in a federation. In various embodiments, the central model is then trained locally by each ANN into a local model. Thus, the central algorithm becomes localized to each individual federation, depending on how the ANN uses the central algorithm for its local application. As a number of ANNs becomes increasingly large, it becomes, for example, computationally impractical for each ANN to share its local model with the central server—due to, for example, bandwidth limitations, privacy concerns, latency problems, transfer costs, etc. Alternatively, each ANN shares only its individual changes to the central model, called updates, with the central server, as opposed to its entire local model as maintained and used by the ANN. Thus, local and unique ANN data stays with the ANN within the federation, and it is not uploaded to, or otherwise shared with, the central server. As the central server receives updates from numerous ANNs in a federation, the central algorithm aggregates the collected updates into the central algorithm, as if the central algorithm was trained on the local data itself, to which the central server did not otherwise have direct access, in various embodiments. The central server then forms a new, modified central algorithm, obtained through federated learning, which it then again distributes to the ANNs of the federation, and which, in turn, is further localized by training at the federate level. In various embodiments, the process iteratively repeats for continuous learning, as maintained by the central server. In this fashion, the AI available from each ANN accumulates learning updates from all ANNs into the central model, while leaving local models intact at each ANN and not sharing them with the central server at any time, in various embodiments. In various embodiments, ANN data and ANN local models thus stay local at each ANN, and only limited, local updates are provided to the central server and used to improve the training of the central algorithm. As a result, machine learning becomes smarter as it gets more updates from more ANNs, while local models remain intact at ANNs, and collaborative sharing improves deeper learning from decentralized federations of ANNs. In addition, the local ANNs draw local inferences from local datasets, such as by using a local inference neural engine (LINE) as part of an ANN.

The central server uses the updates from the ANNs for training the central model, while inferences remain the province of local models at local ANNs, in various embodiments. Thus, the central server trains using multiple ANN updates, not just one update from one ANN, in various embodiments. For example, re-training the central model may occur when the central server receives 10s, 100s, 1,000s, or 10,000s (or the like) of updates that can be aggregrated when re-training the central model, in various embodiments.

As a result, the shared central (e.g., global/seed) model is securely trained under the control of the central server from the federation of participating ANNs. In various embodiments, the small, focused embodiments are sent to the central server and aggregated with other updates in order to improve the shared model. In various embodiments, the central server does not otherwise retain individual updates after the aggregating occurs.

When messages are sent between the central server and the ANNs, they are, in various embodiments, authenticated and encrypted using cryptographic protocols. For example, bi-directional authentication (e.g., via authentication tokens, digital signatures, identity certificates, etc.) ensures communication is only between the central server and particular ANNs within a federation, while encryption ensures only the central server and particular ANNs can decipher that communication.

Referring generally, asymmetric cryptography is a cryptographic protocol that uses multiple (e.g., two) keys between receivers and senders. More specifically, the central server, for example, disseminates a public key to the ANNs of the federation to establish a common root of trust for a trust relationship within the federation, as well as a private key to each individual ANN of the federation. Accordingly, when the central server communicates with the ANNs, or vice versa, the central server and/or ANN is authenticated. In addition, when the central server communicates with the ANNs, or vice versa, the central server uses the central server's public key to encrypt the message. When an ANN receives an encrypted message from the central server, or vice versa, it uses the ANN's private key to decrypt the message. Thus, while the public key is widely disseminated to the ANNs of the federation, the ANNs keep private their private keys, in various embodiments. As such, these software keys must compare favorably for messages to be decrypted between the central server and ANNs, in various embodiments.

The two separate keys (e.g., corresponding key-pairs) establish an asymmetrical cryptographical system for the federation, in which the central server and ANNs use authentication and encryption to ensure effective, secure communications therebetween, in various embodiments.

In various embodiments, metadata is also used as an additional security measure between the ANNs and the central server. For example, in various embodiments, metadata between the central server and the ANNs includes time stamps of data, messages, and updates; a number of inferences per ANN, including as compared to benchmark numbers maintained, and/or computed, by the central server; a number of ANNs within a federation (e.g., a use count); IP addresses and/or physical locations; etc.

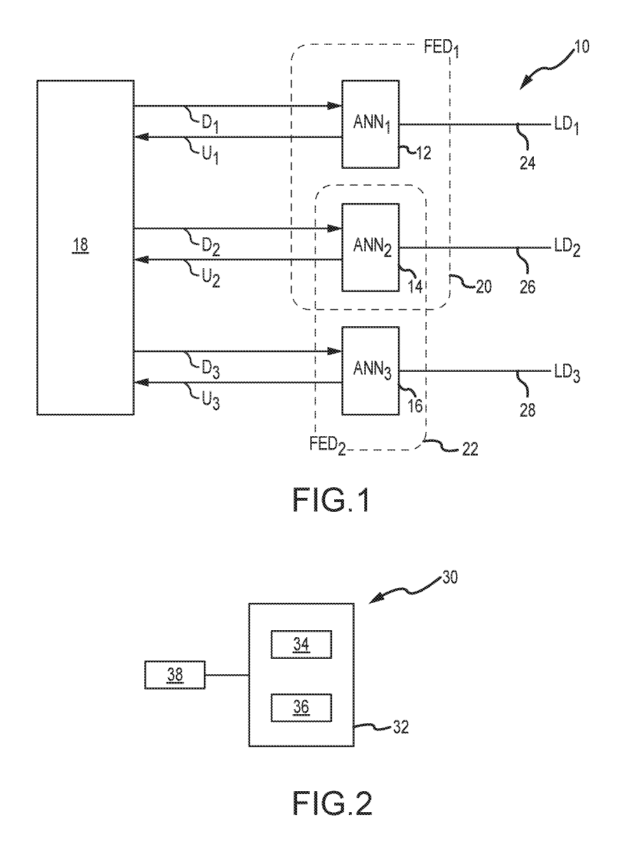

Referring now to FIG. 1, a computer network 10 comprises, for example, a first artificial neural network (ANN₁) 12, a second artificial neural network (ANN₂) 14, a third artificial neural network (ANN₃) 16, and a central server 18.

In various embodiments, one or more of the first artificial neural network (ANN₁) 12, the second artificial neural network (ANN₂) 14, and/or the third artificial neural network (ANN₃) 16 comprise one or more networks of related desktop computers, laptop computers, tablet computing devices, watches, cell phones, mobile devices, smartphones, wearable computing devices, fitness devices, cameras, internet of thing (IOT) devices, appliances, personal digital assistants (PDAs), airplane or automobile or boat or train or truck transportation devices, GPS-enabled devices, gaming devices, media players, music players, etc. In various embodiments, the first artificial neural network (ANN₁) 12, the second artificial neural network (ANN₂) 14, and/or the third artificial neural network (ANN₃) 16 are located within a single installation, multiple installations, a single location, multiple locations, etc.

In various embodiments, the central server 18 comprises one or more servers, one or more computer banks, and/or a distributed computing arrangement, such as in a cloud-based arrangement. In various embodiments, the central server 18 maintains a first download connection D₁ with the first artificial neural network (ANN₁) 12, a second download connection D₂ with the second artificial neural network (ANN₂) 14, and a third download connection D₃ with the third artificial neural network (ANN₃) 16, through which the central server 18 respectively communicates therewith. In like fashion, the first artificial neural network (ANN₁) 12 maintains a first upload connection U₁ with the central server 18, the second artificial neural network (ANN₂) 14 maintains a second upload connection U₂ with the central server 18, and the third artificial neural network (ANN₃) 16 maintains a third upload connection U₃ with the central server 18, through which they respectively communicate therewith.

In various embodiments, the first artificial neural network (ANN₁) 12 and the second artificial neural network (ANN₂) 14 are part of a first federation (FED₁) 20, and the second artificial neural network (ANN₂) 14 and the third artificial neural network (ANN₃) 16 are part of a second federation (FED₂) 22. Notably, one or more of the artificial neural networks is part of multiple federations, such as the second artificial neural network (ANN₂) 14 as a member of the first federation (FED₁) 20 and the second federation (FED₂) 22.

In various embodiments, each client/member (i.e., each ANN) of a federation is in communication with other clients/members (i.e., other ANNs) of the federation through the central server 18—such as, for example, the first artificial neural network (ANN₁) 12 being in communication with the second artificial neural network (ANN₂) 14 of the first federation (FED₁) 20 through the central server 18, and the second artificial neural network (ANN₂) 14 being in communication with the third artificial neural network (ANN₃) 16 of the second federation (FED₂) 22 through the central server 18.

In various embodiments, any given federation may have any given number of members (i.e., artificial neural networks), such as tens, hundreds, thousands, millions, etc.

In various embodiments, the network 10 comprises the Internet, an intranet, a local area network (LAN), metropolitan area networks (MAN), wide area network (WAN), cloud network, cable network, satellite network, wired network, wireless network, and/or other, including various combinations thereof.

After the first artificial neural network (ANN₁) 12 and the second artificial neural network (ANN₂) 14 have affiliated—i.e., been federated into the first federation (FED₁) 20 by the central server 18—they download the central server's 18 central model at the first artificial neural network (ANN₁) 12 and the second artificial neural network (ANN₂) 14, respectively. The first artificial neural network (ANN₁) 12 then trains on first local data (LD₁) 24, and the second artificial neural network (ANN₂) 14 then trains on second local data (LD₂) 26. When an update from the first local model is available, the first artificial neural network (ANN₁) 12 uploads the first update to the central sever 18, using authentication and encryption, in various embodiments. When an update from the second local model is available, the second artificial neural network (ANN₂) 14 uploads the second update to the central sever 18, using authentication and encryption, in various embodiments. When the central sever 18 receives the first update from the first artificial neural network (ANN₁) 12 and the second update from the second artificial neural network (ANN₂) 14, the central server 18 aggregates the updates into the central model for distribution back to the first artificial neural network (ANN₁) 12 and to the second artificial neural network (ANN₂) 14 of the first federation (FED₁) 20. Notably, the central server 18 did not directly train on the first local data (LD₁) 24 or the second local data (LD₂) 26, but it updates the central model as if the central server 18 had done so.

After the second artificial neural network (ANN₂) 14 and the third artificial neural network (ANN₃) 16 have affiliated—i.e., been federated into the second federation (FED₂) 22 by the central server 18—they download the central server's 18 central model at the second artificial neural network (ANN₂) 14 and the third artificial neural network (ANN₃) 16, respectively. The second artificial neural network (ANN₂) 14 then trains on second local data (LD₂) 26, and the third artificial neural network (ANN₃) 16 then trains on third local data (LD₃) 28. When an update from the second local model is available, the second artificial neural network (ANN₂) 14 uploads the second update to the central sever 18, using authentication and encryption, in various embodiments. When an update from the third local model is available, the third artificial neural network (ANN₃) 16 uploads the third update to the central sever 18, using authentication and encryption, in various embodiments. When the central sever 18 receives the second update from the second artificial neural network (ANN₂) 14 and the third update from the third artificial neural network (ANN₃) 16, the central server 18 aggregates the updates into the central model for distribution back to the second artificial neural network (ANN₂) 14 and to the third artificial neural network (ANN₃) 16 of the second federation (FED₂) 22. Notably, the central server 18 did not directly train on the second local data (LD₂) 26 or the third local data (LD₃) 28, but it updates the central model as if the central server 18 had done so.

In addition, via the second artificial neural network (ANN₂) 14 being a member of the first federation (FED₁) 20 and the second federation (FED₂) 22, the first artificial neural network (ANN₁) 12 benefits from the third update from the third artificial neural network (ANN₃) 16, even though the first artificial neural network (ANN₁) 12 and the third artificial neural network (ANN₃) 16 are not affiliated within a common federation. Likewise, the third artificial neural network (ANN₃) 16 benefits from the first update from the first artificial neural network (ANN₁) 12, even though the first artificial neural network (ANN₁) 12 and the third artificial neural network (ANN₃) 16 are not affiliated within a common federation.

Referring now to FIGS. 1-2, computing componentry 30, such as the first artificial neural network (ANN₁) 12, the second artificial neural network (ANN₂) 14, the third artificial neural network (ANN₃) 16, and/or the central server 18 of FIG. 1, comprises one or more controllers 32 having one or more processors 34 operating in conjunction with one or more tangible, non-transitory memories 36 configured to implement digital or programmatic logic, in various embodiments. In various embodiments, for example, the one or more processors 34 comprise one or more of an application specific integrated circuit (ASIC), digital signal processor (DSP), field programmable gate array (FPGA), general purpose processor, microprocessor, and/or other programmable logic device, discrete gate, transistor logic, or discrete hardware components, or any various combinations thereof and/or the like, and the one or more tangible, non-transitory memories 36 store instructions that are implemented by the one or more processors 34 for performing various functions, such as the systems and methods of the inventive arrangements described herein.

In various embodiments, the components and/or functionality described herein also include computer instructions, programs, and/or software that is embodied in one or more external, tangible, non-transitory computer-readable media 38 that is used by the one or more controllers 32. As such, the computer-readable media 38 contains, maintains, and/or stores computer instructions, programs, and/or software that is used by the one or more controllers 32, including physical media, such as, for example, magnetic, optical, and/or semiconductor media, including, for example, flash, magnetic, and/or solid-state devices. In various embodiments, one or more components described herein are implemented as components, modules, and/or subsystems of a single application, as well as using one computing device and/or multiple computing devices.

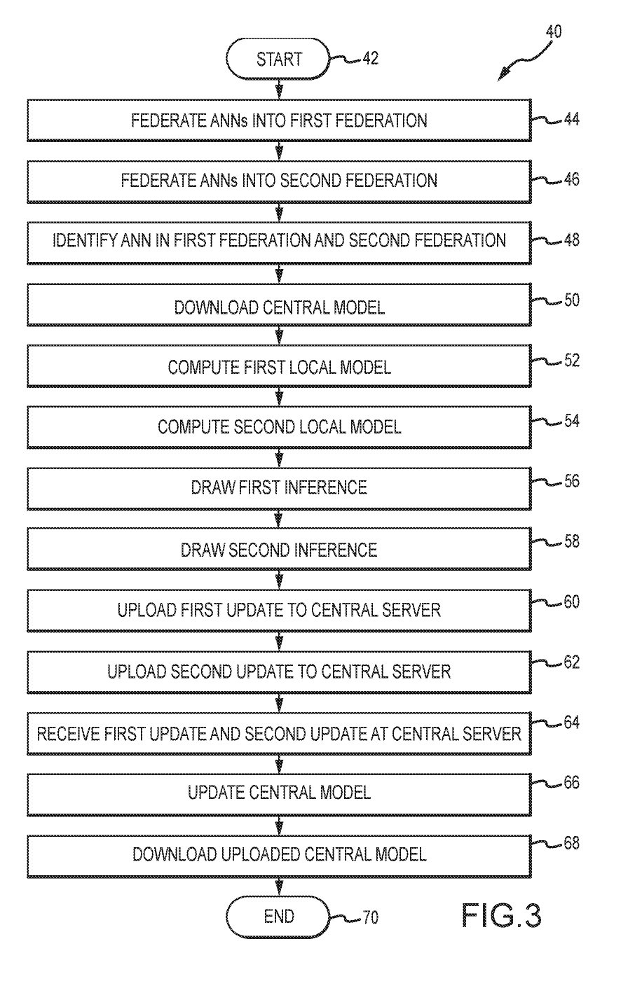

Referring now to FIG. 3, a computer-implemented method 40 begins at a step 42, after which a first plurality of artificial neural networks is federated into a first federation at a step 44, as is a second plurality of artificial neural networks federated into a second federation at a step 46. At a step 48, at least one artificial neural network is identified that is in the first federation and in the second federation. At a step 50, a central model is downloaded from a central server to the first plurality of artificial neural networks and to the second plurality of artificial neural networks. At a step 52, a first local model within the first federation is computed based on the first local data as applied to central model, as is a second local model within the second federation based on the second local data as applied to central model at a step 54. At a step 56, a first inference is drawn using the first local model within the first federation, as is a second inference using the second local model within the second federation at a step 58. At a step 60, a first update from the first local model of the first federation is uploaded to the central server using authentication and encryption, as is a second update from the second local model of the second federation to the central server using authentication and encryption at a step 62. At a step 64, the first update and the second update are received at the central server, and the central model at the central server is updated based on the first update and the second update at a step 66. At a step 68, an updated central model from the central server is downloaded to the first plurality of artificial neural networks and to the second plurality of artificial neural networks, after which the method 40 ends in a step 70.

In accordance with the description herein, technical benefits and effects of this disclosure include securing communications between a central server and clusters of artificial neural networks to update a central model of the central server from local datasets obtained at the edges of the artificial neural networks, without directly exposing the central server to the local datasets. In various embodiments, at least one artificial neural network is affiliated with multiple federations, whereby otherwise unconnected federations receive benefit from external dataset trainings at other federations.

Advantages, benefits, improvements, and solutions, etc. have been described herein with regard to specific embodiments. Furthermore, connecting lines shown in the various figures contained herein are intended to represent exemplary functional relationships and/or physical couplings between the various elements. It should be noted that many additional and/or alternative functional relationships or physical connections may be present in a practical system. However, the advantages, benefits, improvements, solutions, etc., and any elements that may cause any advantage, benefit, improvement, solution, etc. to occur or become more pronounced are not to be construed as critical, essential, or required elements or features of this disclosure.

The scope of this disclosure is accordingly to be limited by nothing other than the appended claims, in which reference to an element in the singular is not intended to mean “one and only one” unless explicitly so stated, but rather “one or more.” It is to be understood that unless specifically stated otherwise, references to “a,” “an,” and/or “the” may include one or more than one, and that reference to an item in the singular may also include the item in the plural, and vice-versa. All ranges and ratio limits disclosed herein may be combined.

Moreover, where a phrase similar to “at least one of A, B, and C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment; for example, A and B, A and C, B and C, or A and B and C. Different cross-hatching may be used throughout the figures to denote different parts, but not necessarily to denote the same or different materials. Like depictions and numerals also generally represent like elements.

The steps recited in any of the method or process descriptions may be executed in any order and are not necessarily limited to the order presented. Furthermore, any reference to singular elements, embodiments, and/or steps includes plurals thereof, and any reference to more than one element, embodiment, and/or step may include a singular one thereof. Elements and steps in the figures are illustrated for simplicity and clarity and have not necessarily been rendered according to any particular sequence. For example, steps that may be performed concurrently or in different order are only illustrated in the figures to help to improve understanding of embodiments of the present, representative disclosure.

Any reference to attached, connected, fixed, or the like may include full, partial, permanent, removable, temporary and/or any other possible attachment option. Additionally, any reference to without contact (or similar phrases) may also include reduced contact or minimal contact. Surface shading lines may be used throughout the figures to denote different areas or parts, but not necessarily to denote the same or different materials. In some cases, reference coordinates may or may not be specific to each figure.

Apparatus, methods, and systems are provided herein. In the detailed description herein, references to “one embodiment,” “an embodiment,” “various embodiments,” etc., indicate that the embodiment described may include a particular characteristic, feature, or structure, but every embodiment may not necessarily include this particular characteristic, feature, or structure. Moreover, such phrases may not necessarily refer to the same embodiment. Further, when a particular characteristic, feature, or structure is described in connection with an embodiment, it is submitted that it is within the knowledge of one skilled in the art to affect such characteristic, feature, or structure in connection with other embodiments, whether or not explicitly described. After reading the description, it will be apparent to one skilled in the relevant art(s) how to implement this disclosure in alternative embodiments.

Furthermore, no component, element, or method step in the present disclosure is intended to be dedicated to the public regardless of whether the component, element, or method step is explicitly recited in the claims. No claim element is intended to invoke 35 U.S.C. § 112(f) unless the element is expressly recited using the phrase “means for.” As used herein, the terms “comprises,” “comprising,” or any other variation thereof, are intended to cover a non-exclusive inclusion, such that an apparatus, article, method, or process that comprises a list of elements does not include only those elements, but it may also include other elements not expressly listed or inherent to such apparatus, article, method, or process.

What is claimed is:

1. A federated architecture of artificial neural networks, comprising:
a first federation comprising a first plurality of artificial neural networks;
a second federation comprising a second plurality of artificial neural networks; and
a central server in communication with the first plurality of artificial neural networks and with the second plurality of artificial neural networks;
wherein at least one artificial neural network is in the first federation and in the second federation;
wherein communication between the central server and the first plurality of artificial neural networks is based on the first federation; and
wherein communication between the central server and the second plurality of artificial neural networks is based on the second federation.

2. The federated architecture of claim 1, wherein the communication is bi-directional.

3. The federated architecture of claim 1, wherein the communication is at least one of encrypted and authenticated using an asymmetrical cryptographic key pair.

4. The federated architecture of claim 1, wherein the communication comprises metadata validation.

5. The federated architecture of claim 1, wherein the central server receives a first update based on first local data from the first plurality of artificial neural networks and a second update based on second local data from the second plurality of artificial neural networks.

6. The federated architecture of claim 5, wherein the central server aggregates the first update and the second update.

7. The federated architecture of claim 6, wherein the central server aggregates the first update and the second update after the central server receives a predetermined number of updates.

8. A computer-implemented method of operating a federated architecture of artificial neural networks, comprising:
federating a first plurality of artificial neural networks into a first federation;
federating a second plurality of artificial neural networks into a second federation;
identifying at least one artificial neural network that is in the first federation and in the second federation;
downloading a central model from a central server to the first plurality of artificial neural networks and to the second plurality of artificial neural networks;
computing a first local model within the first federation based on first local data applied to the central model;
computing a second local model within the second federation based on second local data applied to the central model;
drawing a first inference using the first local model within the first federation;
drawing a second inference using the second local model within the second federation;
uploading a first update from the first local model of the first federation to the central server;
uploading a second update from the second local model of the second federation to the central server;
receiving the first update and the second update at the central server;
updating the central model at the central server based on the first update and the second update; and
downloading an updated central model from the central server to the first plurality of artificial neural networks and to the second plurality of artificial neural networks.

9. The computer-implemented method of operating the federated architecture of claim 8, wherein updating the central model at the central server based on the first update and the second update comprises aggregating the first update and the second update.

10. The computer-implemented method of operating the federated architecture of claim 9, wherein the aggregating occurs after receiving a specified number of updates from the federations before the aggregation.

11. The computer-implemented method of operating the federated architecture of claim 9, wherein the central server discards the first update and the second update after the aggregation.

12. The computer-implemented method of operating the federated architecture of claim 8, wherein at least one of the uploading and downloading comprises authentication.

13. The computer-implemented method of operating the federated architecture of claim 12, wherein at least one of the uploading and the downloading comprises encryption.

14. The computer-implemented method of operating the federated architecture of claim 8, further comprising validating the first update and the second update using metadata.

15. The computer-implemented method of operating the federated architecture of claim 8, wherein the first federation benefits from the second update and the second federation benefits from the first update.

16. The computer-implemented method of operating the federated architecture of claim 15, wherein the first federation benefits from the second update and the second federation benefits from the first update via the artificial neural network that is in the first federation and in the second federation, after training locally on the first local model and the second local model.

17. A non-transitory computer-readable medium embodying program code executable in at least one computing device, the program code, when executed by the at least one computing device, being configured to cause the at least one computing device to at least:
federate a first plurality of artificial neural networks into a first federation;
federate a second plurality of artificial neural networks into a second federation;
identify at least one artificial neural network that is in the first federation and in the second federation;
download a central model from a central server to the first plurality of artificial neural networks and to the second plurality of artificial neural networks;
compute a first local model within the first federation based on first local data applied to the central model;
compute a second local model within the second federation based on second local data applied to the central model;
draw a first inference using the first local model within the first federation;
draw a second inference using the second local model within the second federation;
upload a first update from the first local model of the first federation to the central server;
upload a second update from the second local model of the second federation to the central server;
receive the first update and the second update at the central server;
update the central model at the central server based on the first update and the second update; and
download an updated central model from the central server to the first plurality of artificial neural networks and to the second plurality of artificial neural networks.

18. The non-transitory computer-readable medium of claim 17, wherein the program code is further configured to cause the at least one computing device to aggregate the first update and the second update to update the central model at the central server.

19. The non-transitory computer-readable medium of claim 17, wherein the aggregation occurs after receiving a specified number of updates from the federations before the aggregation.

20. The non-transitory computer-readable medium of claim 18, wherein the program code is further configured to discard the first update and the second update after the aggregation.
